(19) United States
(12) Patent Application Publication
(10) Pub. No.: US 2026/0019331 A1
(43) Pub. Date: Jan. 15, 2026

(54) SYSTEM AND METHOD FOR PROVIDING CONFIGURATION UPDATES TO NETWORK FUNCTIONS IN A COMMUNICATION NETWORK

(71) Applicant: DISH Wireless L.L.C., Englewood, CO (US)

(72) Inventors: Abhishek Jayprakash Shirke, Aurora, CO (US); Prakash Patel, Castle Rock, CO (US); Mohammad Dawood Shahdad, Aurora, CO (US)

(21) Appl. No.: 18/771,925

(22) Filed: Jul. 12, 2024

(51) Int. Cl. H04L 41/0823; H04L 41/08; H04L 41/22

(52) U.S. Cl. CPC H04L 41/0823; H04L 41/0886; H04L 41/22

(57) ABSTRACT

A method for providing a configuration update to a plurality of network functions of a predetermined network function type in a communication network includes receiving a selection of a master network function from the plurality of network functions of the predetermined network function type. The method further includes applying the configuration update to the master network function and providing the configuration update from the master network function to a set of slave network functions from the plurality of network functions of the predetermined network function type. The method further includes receiving a status of the configuration update for each of the slave network functions and displaying the status of the configuration update for each of the slave network functions.

### BACKGROUND

Wireless communication networks that transport digital data and telephone calls are becoming increasingly sophisticated. Currently, fifth generation (5G) broadband cellular networks are being deployed around the world. These 5G networks use emerging technologies to support data and voice communications with millions, if not billions, of mobile phones, computers and other devices. 5G technologies are capable of supplying much greater bandwidths than was previously available.

### SUMMARY

In accordance with an embodiment, a method for providing a configuration update to a plurality of network functions of a predetermined network function type in a communication network includes receiving a selection of a master network function from the plurality of network functions of the predetermined network function type. The method further includes applying the configuration update to the master network function, providing, using the master network function, the configuration update to a set of slave network functions from the plurality of network functions of the predetermined network function type, receiving, using the master network function, a status of the configuration update for each of the slave network functions in the set of slave network functions, and displaying the status of the configuration update for each of the slave network functions in the set of slave network functions.

In accordance wither another embodiment, a system for providing a configuration update to a plurality of network functions of a predetermined network function type in a communication network includes a memory that stored one or more computer readable media that include instructions, and one or more processor devices configured to execute the instructions of the computer readable media to receive a selection of a master network function from the plurality of network functions of the predetermined network function type. The one or more processors are configured to execute the instructions of the computer readable media further to apply the configuration update to the master network function, provide the configuration update from the master network function to a set of slave network functions from the plurality of network functions of the predetermined network function type, receive a status of the configuration update for each of the slave network functions in the set of slave network functions, and display the status of the configuration update for each of the slave network functions in the set of slave network functions.

In accordance with another embodiment, a non-transitory, computer-readable medium storing instructions, that, when executed by an electronic processor, perform a set of functions, the set of functions including receiving a selection of a master network function from a plurality of network functions of a predetermined network function type in a communication network. The set of functions further includes applying the configuration update to the master network function, providing the configuration update from the master network function to a set of slave network functions from the plurality of network functions of the predetermined network function type, receiving, using the master network function, a status of the configuration update for each of the slave network functions in the set of slave network functions, and displaying the status of the configuration update for each of the slave network functions in the set of slave network functions.

### BRIEF DESCRIPTION OF THE DRAWINGS

The present disclosure will hereafter be described with reference to the accompanying drawings, wherein like reference numerals denote like elements.

FIG. 1 is a schematic block diagram of an example communication network in accordance with an embodiment;

FIG. 2 is a schematic block diagram of an example of a service-based architecture of a communication network in accordance with an embodiment;

FIG. 3 is a schematic diagram of an example region-based network topology for a communication network in accordance with an embodiment;

FIG. 4 is a schematic block diagram of a system for providing configuration updates to network functions in a communication network in accordance with an embodiment;

FIG. 5 illustrates a method for providing configuration updates to network functions in a communication network in accordance with an embodiment;

FIG. 6 is an example network function configuration update flow in accordance with an embodiment;

FIG. 7 is an example network function configuration update flow in accordance with an embodiment; and

FIG. 8 is a schematic block diagram of an example computer system in accordance with an embodiment.

### DETAILED DESCRIPTION

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computer device or can be distributed among different computing devices connected by one or more networks or other suitable communication links.

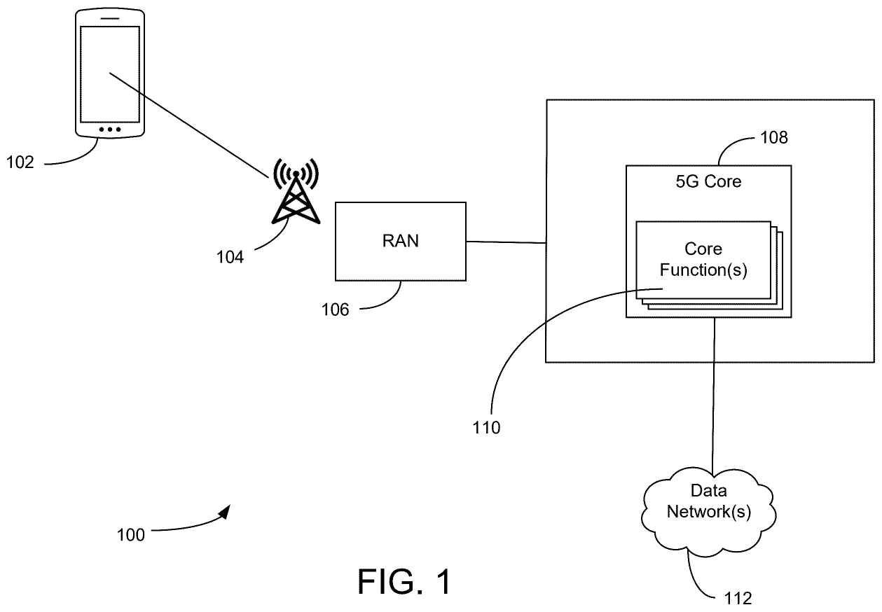

FIG. 1 is a schematic block diagram of an example communication network in accordance with an embodiment. The communication network 100 can include a user equipment (UE) device 102, a radio access network (RAN) 106, and a 5G core 108. The RAN 106 and 5G core 108 can enable the UE device 102 to, for example, communicate with other UE devices and to communicate with one or more external data networks (DNs) 112 (e.g., the Internet or a private corporate network) using the RAN 106 and 5G core 108. For example, if the external data network 112 is the Internet, the RAN 106 and 5G core 108 can allow the UE device 102 to send and receive data via the Internet. While FIG. 1 illustrates various components of communication network 100, other embodiments of communication network 100 can vary the arrangement, communication paths, and specific components of communication network 100. In some embodiments, the wireless communication network 100 can include fewer, additional, or different components in different configurations than illustrated in FIG. 1. For example, in some embodiments, the wireless communication network 100 may include additional or different UE devices 102.

The communication network 100 may be used to facilitate multiple types of communication sessions, such as, for example, voice calls, video calls, messaging, data transmission, and/or other types of communications. The communication network 100 may represent a portion of a wireless network built around 5G (fifth generation) standards promulgated by standards setting organizations under the umbrella of the Third Generation Partnership Project (3GPP). Accordingly, in some configurations, the communication network 100 may be a 5G network, such as, for example, a 5G cellular network. Such 5G networks, including the communication network 100, may comply with industry standards, such as, for example, the Open Radio Access Network (Open RAN or O-RAN) standard that describes interactions between the network and user equipment (e.g., mobile phones and the like). The O-RAN model follows a virtualized model for a 5G wireless architecture in which 5G base stations (gNBs) are implemented using separate centralized units (CUs), distributed units (DUs), and radio units (RUs). In some configurations, O-RAN CUs and DUs may be implemented using software modules executed by distributed (e.g., cloud) computing hardware.

In some configurations, the communication network 100 may be a standalone (SA) network (e.g., a 5G SA network) that utilizes 5G cells for both signaling and information transfer via a 5G packet core architecture. In other configurations, the communication network 100 may be a non-standalone (NSA) network that depends on another network, such as, for example, a control plane of a fourth generation (4G) long-term evolution (LTE) network.

As mentioned, in some embodiments, the UE device 102 can transmit data from one or more applications on the UE device 102 to an external data network (DN) 112, for example, the Internet, via the communication network 100. While FIG. 1 illustrates one UE device 102, in some embodiments, it should be understood that the communication network 100 can support a plurality of UE devices 102. UE device 102 can be various forms of wireless devices that are capable of communication according to the radio access technology (RAT) of the communication network 100 (e.g., a 5G new radio (NR) network). For example, in some embodiments, the UE device 102 can be a smartphone, a wireless modem, a cellular phone, a laptop computer, a wireless access point (AP), etc.

After the UE device 102 has established a connection or session with the RAN 106, the communication network 100 can provide data (e.g., data packets) to the UE device 102 and can receive data from the UE device 102. In some embodiments, the data can include, for example, voice data for a phone call, data provided by a web server to the UE device 102, data provided by the UE device 102 to a Web server, or other types of data commonly exchanged on communication networks. For example, after the UE device 102 has established a connection or session with the RAN 106, a user of the UE device 102 may select to stream a video on an application of the UE device 102 via the Internet (e.g., data network 112). The video stream can be provided to the UE device 102 on data packets.

The UE device 102 can communicate with the RAN 106 in various ways, such as, for example, via a radio transceiver 104, which may also be referred to as a radio unit (RU) in the O-RAN architecture. The RAN 106 may be or include a disaggregated RAN (referred to as an Open RAN or O-RAN) which can include hierarchy (e.g., tree structure) of RAN functions. In such examples, the RAN 106 may include one or more CUs and one or more DUs. For example, each of multiple CUs may be coupled with multiple DU, and each DU may be coupled with multiple RUs (e.g., the radio transceiver 104). As such, each UE device 102 can communicate with backhaul network infrastructure (e.g., a 5G Core 108) according to an assigned communication path through a particular RU, DU, and CU. An RU (e.g., the radio transceiver 104) in combination with a DU and CU may be referred to as a gNodeB (gNB) in the O-RAN architecture. Such a gNB may be a 3GPP 5G next generation base station that supports communications with the with the UE device 102.

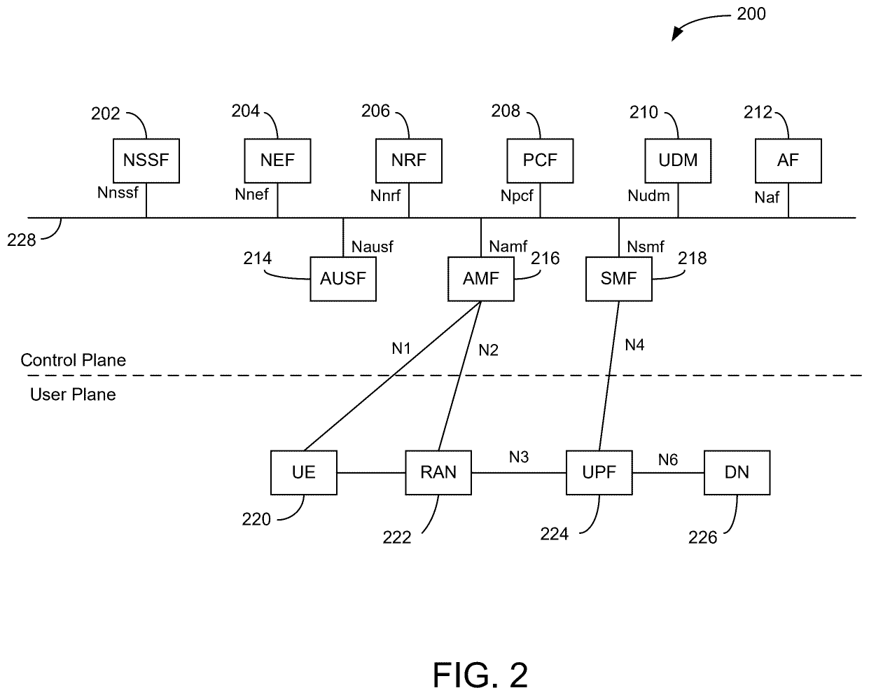

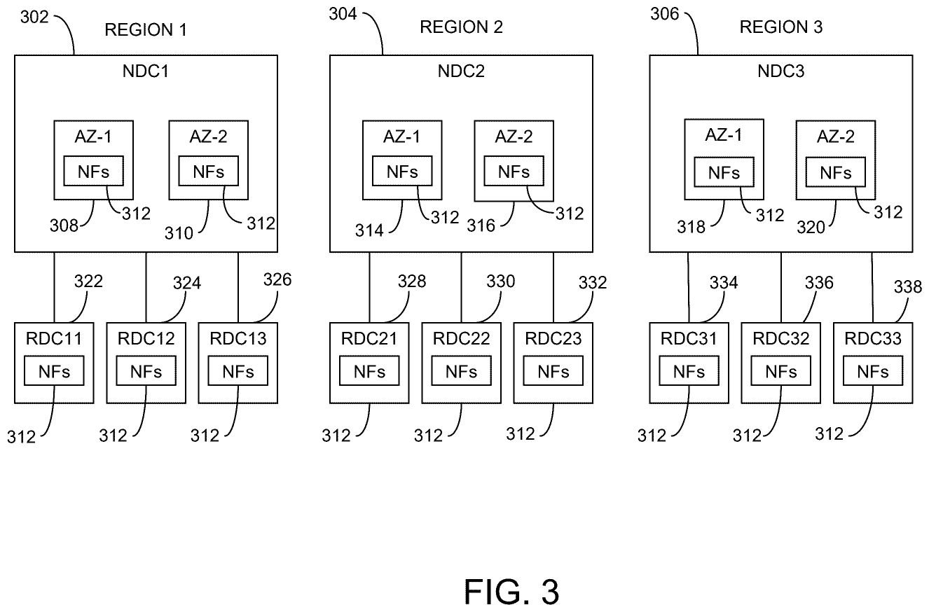

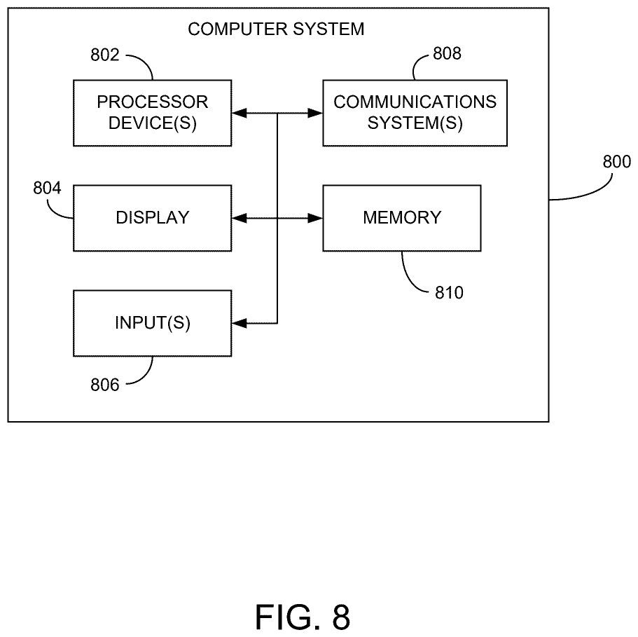

The 5G Core 108 may include one or more core functions 110. Each core function 110 can be a network function (NF) that provides a utility or service specific to the 5G core 108, for example, core functions of the communication network 100. In some embodiments, for example, different NFs may provide different utility to the communication network 100. In some embodiments, the 5G core 108 including the core functions 110 can reside on a cloud computing platform. For example, in some embodiments, the communication network (e.g., communication network 100), or portion thereof, in which the 5G core 108 is implemented may be disaggregated, such that, for example, NFs may be developed or operated by multiple vendors or operators. In some embodiments, an NF may be virtualized. An NF may be virtualized by implementing the NF in a cloud-native architecture. Accordingly, in some embodiments, an NF may be a cloud-native NF (CNF). A CNF may refer to a service (or utility) that performs network duties in software (e.g., as opposed to purpose-built hardware). Examples of various core functions 110 are discussed further below with respect to FIG. 2. In some embodiments, the RAN 106 and the 5G core 108 (including core functions 110) may be implemented on a computer system (e.g., computer system 800 discussed below with respect to FIG. 8) such as a server or the functionality of the RAN 106, the 5G core 109 and core functions 110 may be distributed among multiple servers or devices (e.g., as part of a cloud service or cloud-computing environment). In some embodiments, the 5G core 108 can be physically distributed across data centers or located at a central national data center (NDC) (e.g., the 5G core can logically reside as part of an NDC, for example, in a region-based network topology which is described further below with respect to FIG. 3). Within an NDC, multiple regional data centers (RDCs) can be logically present. In some embodiments, each of such one or more regional data centers may execute core functions 110 for a different geographic region or a group of RAN components.

FIG. 2 is a schematic block diagram of an example of a service-based architecture (SBA) of a communication network in accordance with an embodiment. The SBA 200 is divided between a control plane and a user plane. The control plane includes a plurality of network functions (NFs) 202-218. The user plane includes a UE 220 (e.g., UE 102 shown in FIG. 1) in communication with a RAN 222, and NFs (e.g., UPF 224). In FIG. 2, the SBA 200 can be used for providing communication between the UE device 220 and a data network 226 (e.g., the Internet). In FIG. 2, the example 5G core is simplified to show some key components, however, implementations can involve additional components. In some embodiments, the communication network (e.g., communication network 100 shown in FIG. 1), or portion thereof, in which the 5G core is implemented may be disaggregated, such that, for example, NFs may be developed or operated by multiple vendors or operators. In some embodiments, an NF may be virtualized. An NF may be virtualized by implementing the NF in a cloud-native architecture. Accordingly, in some embodiments, an NF may be a cloud-native NF (CNF). A CNF may refer to a service (or utility) that performs network duties in software (e.g., as opposed to purpose-built hardware). For ease of illustration, FIG. 2 only shows a single UE 220 being connected to the RAN 222, however, in practical implementations any number of UEs 220 can be present, limited only by the capacity of the network.

In the example architecture illustrated in FIG. 2, the NFs can include a Network Slice Selection Function (NSSF) 202, a Network Exposure Function (NEF) 204, a Network Repository Function (NRF) 206, a policy control function (PCF) 208, a Unified Data Management (UDM) function 210, an Application Function (AF) 212, an Authentication Server Function (AUSF) 214, an Access and Mobility Management Function (AMF) 216, a Session Management Function (SMF) 218, and a User Plane Function (UPF) 224. The NSSF 202 can provide tailor made logical networks on the physical network, for example, the NSSF can be used by the AMF 216 to assist with the selection of a network slice that will serve a particular UE device. The NEF 204 can expose services and resources over application programming interfaces (APIs) within and outside the 5G core. The NRF 206 can enable 5G network functions (NFs) to register and discover each other via a standards-based application programming interface (API). The PCF 208 can apply session policies for the UE device 220, or other devices, when connecting over, for example, 5G. The UDM 210 can manage network user data in a single, centralized element and can allow for generation of authentication vectors, user identification handling, NF registration management, and retrieval of UE device individual subscription data for slice selection. The AF 212 can interact with the 3GPP Core Network in order to provide serviced, for example, to support one or more of application function influence on traffic routing, application function influence on service function chaining, accessing the NRF 212, interacting with the PCF 216, time synchronization service, IP multimedia subsystem (IMS) interactions with the 5GC, or packet data unit (PDU) set handling. The AUSF 214 can allow the AMF 216 to authenticate the UE and access services of the 5G core. The AMF 216 can perform operations like mobility management, registration management, connection management, UE-based authentication, etc. The SMF 218 can interact with the decoupled data plane, can perform internet protocol (IP) address allocation and management for UE devices (e.g., UE device 220), user plane selection, and packet routing in conjunction with the UPF 224, etc. The UPF 224 can perform user plane operations, such as maintaining protocol data unit (PDU) sessions, packet routing and forwarding, inspection policy enforcement for the user plane, Quality of Service (QoS) handling, providing data access to the UE 220, etc. A PDU session can provide connectivity between applications on the UE device 220 and the DN 226 (e.g., the Internet). The SMF 218 can also be responsible for creating, updating, and removing PDU sessions, selecting particular UPFs 224 on which to anchor PDU sessions when new UE devices 220 appear on the communication network, and managing session context with the UPF 224. Together with the UPF 224, the SMF 218 can maintain a record of PDU session state by means of a PDU Session ID.

The SBA 200 may also include a plurality service-based interfaces (SBIs) 228 to provide access to or communicate with the various NFs. As illustrated, such service-based interfaces may include an Nnssf interface for the NSSF 202, an Nnef interface for the NEF 204, an Nnrf interface for the NRF 206, an Npcf interface for the PCF 208, an Nudm interface for the UDM 210, an Naf interface for the AF 212, an Nausf interface for the AUSF 214, an Namf interface for the AMF 216, and an Nsmf interface for the SMF 218. In some embodiments, the UE 220 can communicate with the RAN 222 wirelessly, for example, via a radio transceiver 104 (shown in FIG. 1). The AMF 216 and the UE 220 can communicate signals or messages with another over, for example, an N1 interface. The AMF 216 and the RAN 222 can communicate signals or messages with one another over, for example, an N2 interface. The RAN 222 and the UPF 224 can communicate signals and data with one another over, for example, an N3 interface. The SMF 218 and the UPF 24 can communicate signals or messages with one another over, for example, an N4 interface. The UPF 224 can send and receive signals and data with the Internet 226 over an Internet interface, for example, an N6 interface. The AMF 216 and the SMF 218 can communicate signals and messages with one another over an interface, for example, an N11 interface.

The above-listed NFs and interfaces are intended to be illustrative and not exhaustive. In practical implementations, the SBA 200 may include additional NFs and other network entities, such as an SNPN Authentication and Authorization Function (NSSAAF), a Network Data Analytics Function (NWDAF), a United Data Repository (UDR), a 5G-Equipment Identity Register (5G-EIR), a Charging Function (CHF), a Service Communication Proxy (SCP), a Security Edge Protection Proxy (SEPP), a Home Subscriber Service (HSS), a Home Location Register (HLR), a Binding Support Function (BSF), a Policy and Charging Rules Function (PCRF), a Call Session Control Function (CSCF), a Session Border Control Function (SBC), a Media Resource Function (MRF), a Short Message Service Function (SMSF), or a Rich Communication Services Application (RCS).

As mentioned, in some embodiments, the communication network 100 (shown in FIG. 1) may be configured according to a region-based network topology. FIG. 3 is a schematic diagram of an example region-based network topology for a communication network in accordance with an embodiment. In some embodiments, the communication network (e.g., communication network 100 shown in FIG. 1) may be implemented using a cloud computing platform that is logically and physically divided up into various different cloud computing regions (e.g., AWS regions), for example, Region 1 (or a first national data center (NDC1) 302), Region 2 (or a second nation data center (NDC2) 304), and Region 3 (or a third national data center (NDC3) 306), as shown in FIG. 3. The cloud computing regions 302, 304, 306 may be based on the geographical location of the gNBs; for example, the communication network for a given nation may be divided into a number of geographical regions. Each of the cloud computing regions 302, 304, 306 can be isolated from other cloud computing regions to help provide fault tolerance, fail-over, load-balancing, and/or stability and each of the cloud computing regions can be composed of multiple availability zones or markets. For example, as illustrated in FIG. 3, the first region 302 includes a first availability zone 308 and a second availability zone 310, the second region 304 includes a first availability zone 314 and a second availability zone 316, and the third region 306 includes a first availability zone 318 and a second availability zone 320. Each availability zone can be a separate data center (or datacenters) located in general proximity to each other (e.g., within 100 miles). For example, one cloud computing region may have its datacenters and hardware located in the northeast of the United States while another cloud computing region may have its data centers and hardware located in California. Each of the availability zones may be a discrete data center or group of data centers that allows for redundancy, thereby to provide fail-over protection from other availability zones within the same cloud computing region. For example, when a particular data center of an availability zone experiences an outage, another data center of the availability zone or separate availability zone within the same cloud computing region can continue functioning and providing service. As mentioned, within an NDC 302, 304, 306, multiple regional data centers (RDCs) can be logically present. In FIG. 3, the first region 302 includes a first RDC 322, a second RDC 324, and a third RDC 326. The second region 304 includes a first RDC 328, a second RDC 330, and a third RDC 332. The third region includes a first RDC 334, a second RDC 336, and a third RDC 338. While three regions (or NDCs) 302, 304, 306. each including two availability zones, are illustrated in FIG. 3, it should be understood that, in some embodiments, a communication network may include fewer or more regions (or NDCs) and each region can include more than two availability zones. While each region 302, 304, 306 is shown with three RDCs in FIG. 3, it should be understood that, in some embodiments, a communication network may include fewer or more RDCs per region.

As mentioned, the network functions of the 5G core 108 (shown in FIG. 1 and SBA 200 in FIG. 2) can be distributed across data centers, for example, across the availability zones 308-320 of the national data centers 302, 304, 306 and/or the regional data centers 322-338. In the example illustrated in FIG. 3, network functions 312 can be associated with different availability zones 308-320 in the three regions 302, 304, 306 and can be executed by one or more of the regional data centers 322-338. Accordingly, there can be an instance of a particular type of network function in different regions, availability zones, and at different regional data centers within a region and availability zone. For example, an AMF network function may be logically deployed at each of the regional data centers 322, 324, 326 of the first region 302, logically deployed at each of the regional data centers 328, 330, 332 of the second region 304, and logically deployed at each of the regional data centers 334, 336, 338 of the third region 306. In another example, a PCF function may be logically deployed at a data center associated with each of the availability zones 308, 312 of the first region 302, logically deployed at a data center associated with each of the availability zones 314, 316 of the second region 304, and logically deployed at a data center associated with each of the availability zones 318, 320 of the third region 306.

Configuration updates that are common to all or a subset of instances of a particular type of network function (e.g., NSSF, NEF, NRF, PCF, UDM, AF, AMF, SMF, etc.) may need to be provided during operation of the communication network. As used herein, a configuration update can include, for example, changes to a configuration, changes to parameters, changes to policies, etc. Conventional communication systems can require that an operator or administrator of a communication service provider (CSP) associated with the communication network must access (e.g., login) to each separate instance of the network function and manually add any configuration updates which can be time consuming and can be subject to human error (e.g., adding the wrong configuration or missing important parameters). The present disclosure describes a system and method for providing configuration updates to network functions in a communication network. In some embodiments, for network functions of the same type, one of the network functions can be selected as a master network function (or primary network function) for providing common configuration updates to one or more other network functions of the same type (e.g., a set of slave network functions). In some embodiments, once the configuration of the selected master network function has been updated, the master network function can be configured to provide (e.g., push) the configuration update to the set of slave network functions. In some embodiments, each slave network function can provide a status of the configuration update to the master network function. The disclosed system and method for providing configuration updates to network functions in a communication network can advantageously reduce the time required to implement or make a configuration update for two or more network functions of the same type and reduce or eliminate human error.

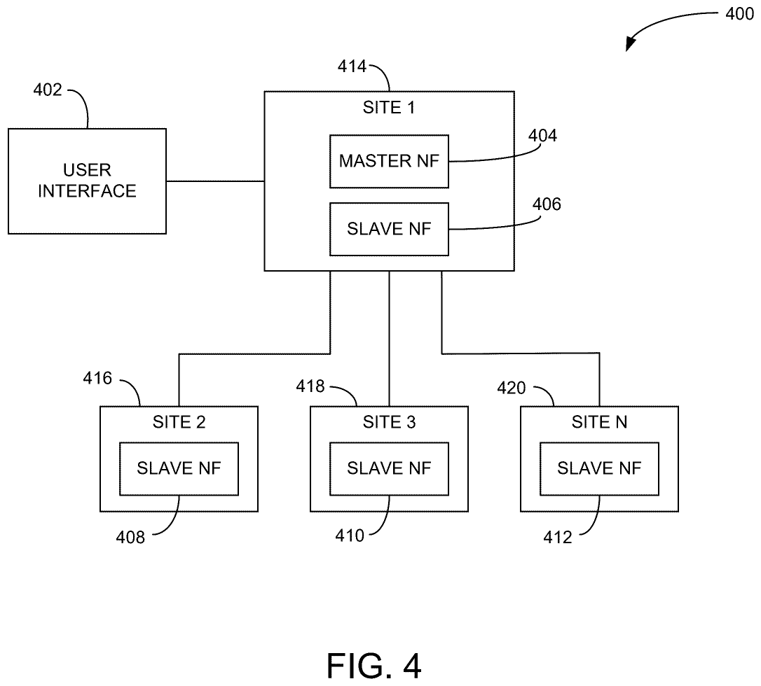

FIG. 4 is a schematic block diagram of a system for providing configuration updates to network functions in a communication network in accordance with an embodiment. In FIG. 4, the system 400 can include a user interface 402, a plurality of instances of a network function type (e.g., NSSF, NEF, NRF, PCF, UDM, AF, AMF, SMF, etc.) including a master network function 404, and a set of slave network functions 406, 408, 410, 412. Instances of the network function type can be at a logical location (or site, e.g., a regional data center) in the communication network, for example, a first site 414, a second site 416, a third site 418, and an Nth site 420. In some embodiments, one or more instances of the network function type can be located at a particular site 414, 416, 418, 420. For example, in FIG. 4, a master NF 404 and a slave NF 406 are both located at the first site 414, a slave NF 408 is located at the second site 416, a slave NF 410 is located at the third site 418, and a slave NF 412 is located at the Nth site 420. In another example, the master NF 404 may be the only instance of the network function type at a particular site. While one slave NF is shown at each site in FIG. 4, it should be understood that, in some embodiments, more than one slave NF may be located at a particular site. In some embodiments, one or more of the N sites 414, 416, 418, 420 can be in different regions, one or more of the N sites 414, 416, 418, 420 can be in the same region, one or more of the N sites 414, 416, 418, 420 can be in different availability zones of the same region, one or more of the N sites 414, 416, 418, 420 can be in the same availability zone of the same region, one or more of the N sites 414, 416, 418, 420 can be in different availability zones in different regions, one or more of the N sites 414, 416, 418, 420 can be in different RDC's associated with the same or different regions or availability zones, and/or one or more of the N sites 414, 416, 418, 420 can be in the same RDC. The user interface 402 can be configured to allow an operator or administrator of a communication network (e.g., communication network 100 shown in FIG. 1) to select and access an instance of a network function at a logical location (or site) in the communication network (e.g., at a regional data center). The user interface 402 (e.g., inputs 806 shown in FIG. 8) can include any suitable input devices and/or sensors that can be used to receive a user input, such as a keyboard, a mouse, a touchscreen, a microphone, a graphical user interface (GUI). a voice user interface (VOI), mechanical switches, buttons, knobs, etc.

As mentioned, the master network function 404 and the slave network functions 406, 408, 410, 412 are the same type of network function (e.g., PCF). In some embodiments, a configuration update may be required for two or more instances of the network function type. In some embodiments, an operator or administrator can define a common configuration update for a specific type of network function. A configuration update for a PCF network function can include, for example, a change to a policy tool or policy that may be common for the PCF in, for example, each region or availability zone, a network attach definition file (e.g., containing at least information regarding peer NFs), access and mobility (AM) policy, session management (SM) policy, UE policy, slice configuration information, etc. A configuration update for an NSSF network function can include, for example, slice configuration information, a network attach definition file, etc. A configuration update for an NRF, NEF, UDM, AF, BSF, UDR, and AUSF network function can include for example, a network attach definition file, etc. A configuration update for an AMF network function can include, for example, a network attach definition file, TAC information (e.g., add, delete, update, block, unblock), slice configuration information, etc. A configuration update for an SMF network function can include, for example, a network attach definition file, whitelisting of uniform resource locators (URLs), static policy, policy and charging control (PCC) rules, timers, data network name (DNN) configurations, slice configuration information, etc. A configuration update for a UPF network function can include, for example, a network attach definition file, whitelisting of URLS, etc. A configuration update for an epdG (evolved packet data gateway) network function can include, for example, a network attach definition file, a security profile, a DNN configuration, slice configuration information, etc.

In some embodiments, an operator or administrator can determine which instances of a particular network function type should be provided with the configuration update. For example, in some embodiments, there may be configuration updates that can be relevant for all of the instances of the network function type in the communication network and, in some embodiments, there may be configuration updates that may be relevant for instances of the network function type in, for example, certain availability zones, therefore only a subset of the total number of the network function type would require the configuration update. In addition, in some embodiments, an operator or administrator can define a specific set of tasks that would be common across all instances of a particular type of network function in the communication network.

An operator or administrator may select one of the instances of the network function type as a master network function 404. In the system illustrated in FIG. 4, the selected master network function 404 can be at a first site 412, for example, associated with a particular region or availability zone. The user interface 402 can be used to access the master network function 404 and make the configuration update to the master network function 404. The selected master network function 404 can be advantageously configured to provide or propagate (e.g., push) the configuration update to the other instances of the network function type at different sites (e.g., associated with different regions or availability zones. associated with the same regions or availability zones, etc.) in the communication network, for example, to slave network function 406 at the first site 414, to slave network function 408 at the second site 416, to slave network function 410 at the third site 418, and to slave network function 412 at the Nth site 420.

Accordingly, the master network function 404 can be configured to include the disclosed synchronization mechanism for common configuration updates for instances of the same type of network function in the communication network. As mentioned, in some embodiments, the set of slave network functions to be updated by the master network function 404 can include all the remaining instances (excluding the selected master network function 404) of the network function type in the communication network. In some embodiments, the set of slave network functions can include fewer than all the remaining instances of the network function type (e.g., a set of at least one of the remaining instances of the network function type). For example, if there are five instances of a network function type, one of the instances of the network function type can be selected as the master network function and at least one of the four remaining instances may be selected for the set of slave network functions. In some embodiments, each slave network function 406, 408, 410, 412 can provide a status of the configuration update to the master network function 404. In some embodiments, the status of the configuration update for the slave network functions 406, 408, 410. 412 can be displayed to the operator or administrator, for example, on a display of the user interface 402. In an example, a graphical user interface can be displayed to illustrate graphically how the configuration update is being promulgated though the slave network functions 406, 408, 410, 412 based on the communications between the master network function 404 and the slave network functions 406, 408, 410. 412. For example, the graphical user interface can be configured to display how many and which slave network functions have been successfully updated, how many and which slave network functions have not been successfully updated, any error for specific slave network functions, etc.

In some embodiments, the master network function 404 and the slave network functions 406, 408, 410. 412 can communicate with each other via the service based interfaces (SBIs) of the communication network (e.g., the SBIs 228 illustrated in FIG. 2). In some embodiments, the master network function 404 can communicate (e.g., push) the common configuration update to the slave network functions 406, 408, 410, 412 using a configuration replication channel. In some embodiments, each site 414, 416, 418, 420 can include a plurality of configuration replication channels. In some embodiments, one of the plurality of configuration replication channels can be used as the active channel used to communicate the configuration updates from the master NF 404 and one or more of the plurality of configuration replication channels can be designated as backup channels. In an example, if the active configuration replication channel used to communication the configuration update from the master NF fails, the master NF 404 can use one of the backup configuration replication channels to communication the configuration update to the slave NFs 406, 408 410, 412. In some embodiments, if there is a failure of the master network function 404 (or a failure of the site 414 on which the master network function is located), one of the slave network functions 406, 408, 410, 412 can be used to provide the configuration update across the other slave network functions.

In some embodiments, a communication protocol such as, for example, hypertext transfer protocol (HTTP), HTTPS and HTTP2, can be used to communicate the configuration updates from the master network function 404 to the slave network functions 406, 408 410 and to communicate the status of the configuration update from each slave network function 406, 408, 410 to the master network function 404. In an example, a Representational State Transfer (REST) application programming interface (API) can be used to enable communication with an HTTP/HTTPS protocol. Examples of methods use to communicate the communication updates and status of the communication updates can include, for example, a GET command (retrieves a new resource), a POST command (creates new resource), PUT (update an existing resource), DELETE (remove a specific resource), and PATCH (partially updates an existing resource). In the REST API example, a response can be either a success or an error. A success response can typically include the requested information or a message confirming that the requested action was completed. An error response can include a message explaining why the request could not be completed. For the HTTP/HTTPS/HTTP2 communication protocol, various status codes can be used in a response from a slave network function including, for example, 2xx for success, 3xx for redirection, 4xx for problem with the client, and 5xx for problem with the server.

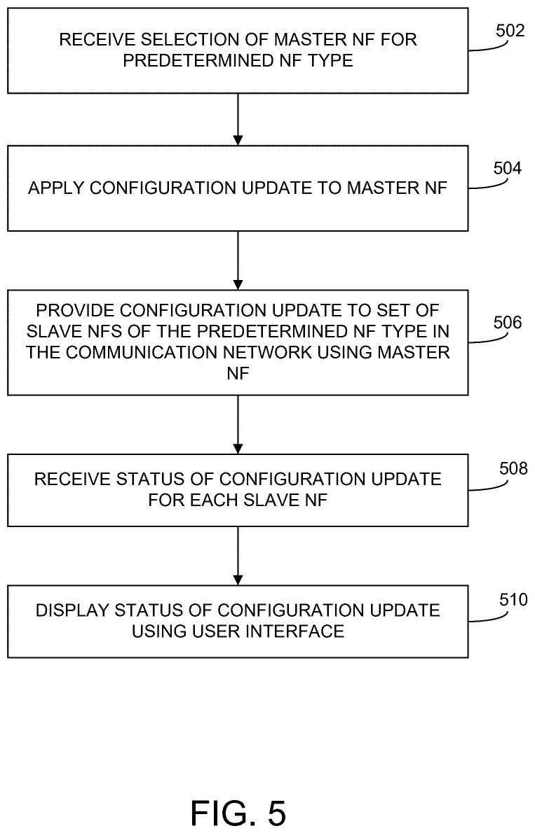

FIG. 5 illustrates a method for providing configuration updates to network functions in a communication network in accordance with an embodiment. The process illustrated in FIG. 5 is described as being carried out by the system illustrated in FIG. 4. However, in some examples, the process of FIG. 5 may be implemented by another system. Although the blocks of the process are illustrated in a particular order, in some embodiments, one or more blocks may be executed in a different order than illustrated in FIG. 5, or may be bypassed.

At block 502, a selection of a master network function 404 for a predetermined network function type can be received. For example, in some embodiments, an operator or administrator of the communication network (e.g., communication network 100) can select a master network function using a user interface 402. At block 504, a configuration update may be applied to the master network function 404, for example, an operator or administrator may use the user interface 402 to access the master network function 404 and make the configuration update to the master network function 404. As mentioned, in some embodiments, the operator or administrator may define the common configuration update for a specific type of network function (e.g., PCF). In some embodiments, the configuration update may be required for two or more instances of the network function type, where each instance of the network function is at a different logical location (or site 414, 416, 418, 420).

At block 506, the master network function 404 can provide (e.g., push) the configuration update to a set of slave network functions 406, 408, 410, 412 of the predetermined network function type in the communication network. In some embodiments, the configuration update may be relevant for all of the instances of the predetermined network function type in the communication network. Accordingly, in this embodiment, all remaining instances of the predetermined network function type that are not selected as the master network function can be included in the set of slave network functions that can be updated by the master network function. For example, if there are seven instances of the predetermined network function type in the communication network, one of the instances of the predetermined network function type can be selected as the master network function 404 and the set of slave network functions can include the remaining six instances of the predetermined network function type. In some embodiments, the configuration update may be relevant for a subset (e.g., fewer than all) of the instances of the predetermined network function type in the communication network, for example, the configuration update may be relevant only for certain availability zones. In an example, if the configuration update is relevant for only two availability zones which include four instances of the predetermined network function type, the set of slave network functions to be updated by the master network function 404 can include these four instances of the predetermined network function type. As mentioned, in some embodiments, the synchronization mechanism in the master network function 404 used to provide or promulgate the configuration update to the set of slave network functions can be configured to utilize the service based interfaces (SBIs) of the communication network (e.g., the SBIs illustrated in FIG. 2) to communicate with the slave network functions 406, 408, 410.

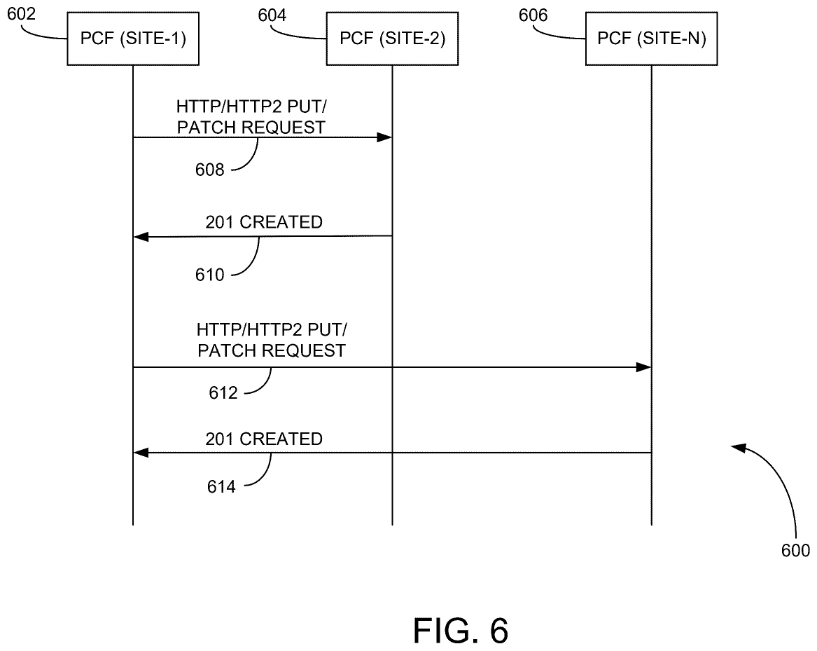

At block 508, a status of the configuration update for each slave network function 406, 408, 410, 412 in the set of slave network functions can be received by the master network function 404. In some embodiments, a communication protocol such as, for example, hypertext transfer protocol (HTTP), HTTPS and HTTP2, can be used to communicate the configuration updates from the master network function 404 to the slave network functions 406, 408, 410, 412 at block 506 and to communicate the status of the configuration update from each slave network function 406, 408, 410, 412 to the master network function 404 at block 508. FIG. 6 is an example network function configuration update flow 600 in accordance with an embodiment. In FIG. 6, the network function type is PCF. A PCF at a first site 602 can be utilized as the master network function in this example, a PCF at a second site 604 can act as a first slave network function, and a PCF at an Nth site 606 can act as a second slave network function. In this example, an HTTP/HTTPS/HTTP2 PUT/PATCH request 608 is illustrated as being communicated from the master network function 602 to the first slave network function 604 and a response 610 including a status code (201) and a “created” status can be communicated from the first slave network function 604 to the master slave network function 602 to indicate that configuration update at the first slave network function 604 was successful. In this example, an HTTP/HTTPS/HTTP2 PUT/PATCH request 612 is illustrated as being communicated from the master network function 602 to the second slave network function 606 and a response 614 including a status code (201) and a “created” status can be communicated from the second slave network function 606 to the master slave network function 602 to indicate that configuration update at the second slave network function 606 was successful.

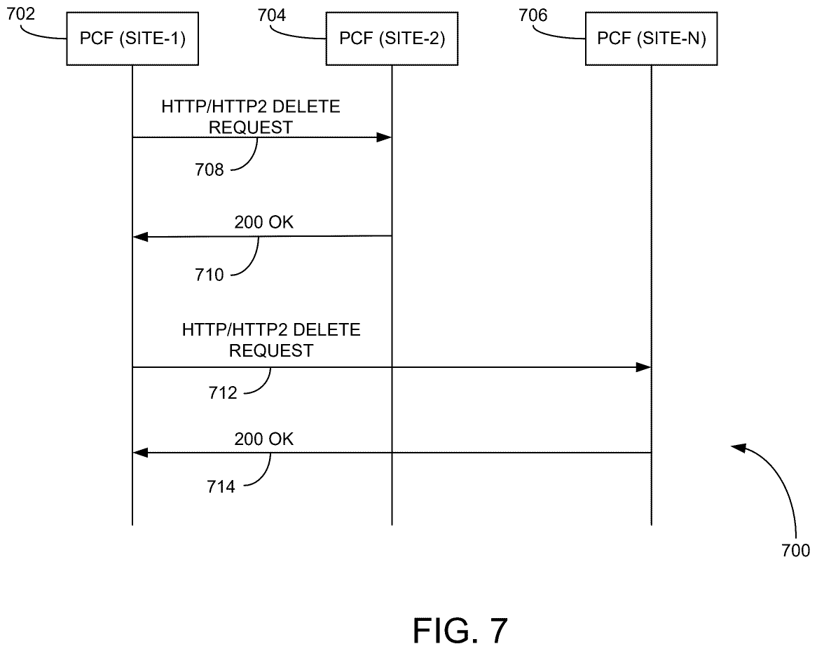

FIG. 7 is an example network function configuration update flow in accordance with an embodiment. In FIG. 7, the network function type is PCF. A PCF at a first site 702 can be utilized as the master network function in this example, a PCF at a second site 704 can act as a first slave network function, and a PCF at an Nth site 706 can act as a second slave network function. In this example, an HTTP/HTTPS/HTTP2 DELETE request 708 is illustrated as being communicated from the master network function 702 to the first slave network function 704 and a response 710 including a status code (200) and an “OK” status can be communicated from the first slave network function 704 to the master slave network function 702 to indicate that configuration update at the first slave network function 704 was successful. In this example, an HTTP/HTTPS/HTTP2 delete request 712 is illustrated as being communicated from the master network function 702 to the second slave network function 706 and a response 714 including a status code (200) and an “OK” status can be communicated from the second slave network function 706 to the master slave network function 702 to indicate that configuration update at the second slave network function 706 was successful.

Returning to FIG. 5, at block 510, the status of the configuration update for each slave network function in the set of slave network functions can be displayed on a display using, for example, a graphical user interface (e.g., user interface 402). In some embodiments, the status of the configuration update for the set of slave network functions 406, 408, 410, 412 can be displayed to the operator or administrator of the communication network. As mentioned, in one example, a graphical user interface can be displayed to illustrate graphically how the configuration update is being promulgated though the slave network functions 406, 408, 410, 412 based on the communications between the master network function 404 and the slave network functions 406, 408, 410. For example, the graphical user interface can be configured to display how many and which slave network functions have been successfully updated, how many and which slave network functions have not been successfully updated, any error for specific slave network functions, etc.

As mentioned above, various components of the disclosed system and method for providing configuration updates to network functions in a communication network may be implemented on a computer system. FIG. 8 is a schematic block diagram of an example computer system in accordance with an embodiment. The computer system 800 (e.g., a server) may include one or more processor devices 802, a display 804, one or more inputs 806, one or more communication systems 808, and memory 810. In some embodiments, processor device(s) 802 can be any suitable hardware processor or combination of processors, such as a central processing unit (CPU), a graphics processing unit (GPU), a microprocessor, an application specific integrated circuit (ASIC), field programmable gate arrays (FPGA), digital signal processors (DSPs), etc. The processor device(s) 802 may include one or more processors, processor cores, processing elements, processor clusters, or other electronic processing units. Accordingly, a processing function described as being performed by the processor device(s) 802 may include multiple processors, processor cores, processing elements, processing clusters, etc. (of the processor device(s) 802) performing aspects or portions (sub-functions) of the processing function to complete the processing function. The one or more electronic processing units of the processor device(s) 802 may include one or more microprocessors, application-specific integrated circuits (“ASICs”), or other suitable electronic device for processing data. At least in some examples, the one or more electronic processing units of the processor device(s) 802 can be co-located physically (e.g., in the same facility, building, room, rack, or computing housing) as part of the computer system 800.

In some embodiments, display 804 can include any suitable display devices, such as a computer monitor, a touchscreen, a television, etc. In some embodiments, display 804 can be omitted. In some embodiments, inputs 806 can include any suitable input devices and/or sensors that can be used to receive user input, such as a keyboard, a mouse, a touchscreen, a microphone, a graphical user interface (GUI), a voice user interface (VOI), mechanical switches, buttons, knobs, etc. and allow a user or operator to interact with the system for sentiment analysis. In some embodiments, inputs 806 can be omitted.

In some embodiments, communications system(s) 808 can include any suitable hardware, firmware, and/or software for communicating information over any suitable communication network (e.g., communication network 100 shown in FIG. 1). For example, communication system(s) 808 can include one or more transceivers, one or more communication chips and/or chip sets, etc. In a more particular example, communication system(s) 808 can include hardware, firmware and/or software that can be used to establish a Wi-Fi connection, a Bluetooth connection, a cellular connection an Ethernet connection, etc.

In some embodiments, memory 810 can include any suitable storage device or devices (e.g., one or more non-transitory computer readable media) that can be used to store instructions, values, etc., that can be used, for example, by processor device 802 to present content using display 804, to communicate with a communication network, to communicate with other computer systems, etc. Memory 810 can include any suitable volatile memory, non-volatile memory, storage, or any suitable combination thereof. For example, memory 810 can include RAM, ROM, EEPROM, one or more flash drives, one or more hard disks, one or more solid state drives, one or more optical drives, etc. The memory 810 may store data and/or instructions for use and execution by the computer system 800 (e.g., by the processor device(s) 802) to implement the functionality of, for example, the user interface, the master NF, the slave NFs, etc. described herein. For example, the memory 810 may include or store the user interface 402, the master NF 404, and the slave NFs 406-412 shown in FIG. 4, respectively. In some embodiments, the functionality described herein as being performed by the computer system 800 may be distributed among multiple computer systems, servers or devices (e.g., as part of a cloud service or cloud-computing environment).

In some examples, aspects of the technology, including computerized implementations of methods according to the technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, examples of the technology can be implemented as a set of instructions, tangibly embodies on a non-transitory computer-readable media, such that a processor device can implement the instructions based upon reading the instructions from the computer-readable media. Some examples of the technology can include (or utilize) a control device such as an automation device, a special purpose or general-purpose computer including various computer hardware, software, firmware, and so on. As specific examples, a control device can include a processor, a microcontroller, a field-programmable gate array, a programmable logic controller, logic gates, etc., and other types of components that are known in the art for implementation of appropriate functionality (e.g., memory, communication systems, power sources, user interfaces, and other inputs, etc.).

Certain operations of the methods according to the technology, or of systems executing those methods, can be represented schematically in the FIGs. or otherwise discussed herein. Unless otherwise specified or limited, representation in the FIGs. of particular operations in particular spatial order can not necessarily require those operations to be executed in a particular sequence corresponding to the particular spatial order. Correspondingly, certain operations represented in the FIGs., or otherwise disclosed herein, can be executed in different orders than are expressly illustrated, as appropriate for particular examples of the technology. Further, in some examples, certain operations can be executed in parallel, including by dedicated parallel processing devices, or separate computing devices configured to interoperate as part of a large system.

The present technology has been described in terms of one or more preferred embodiments, and it should be appreciated that many equivalents, alternatives, variations, and modifications, aside from those expressly stated, are possible and within the scope of the invention.

1. A method for providing a configuration update to a plurality of network functions of a predetermined network function type in a communication network, the method comprising:
receiving a selection of a master network function from the plurality of network functions of the predetermined network function type;
applying the configuration update to the master network function;
providing, using the master network function, the configuration update to a set of slave network functions from the plurality of network functions of the predetermined network function type;
receiving, using the master network function, a status of the configuration update for each of the slave network functions in the set of slave network functions; and
displaying the status of the configuration update for each of the slave network functions in the set of slave network functions.

2. The method according to claim 1, wherein the configuration update relates to a subset of the plurality of network functions of the predetermined network function type and the set of slave network functions comprises the subset of the plurality of network functions of the predetermined network function type.

3. The method according to claim 1, wherein the configuration update relates to all of the network functions in the plurality of network functions of the predetermined network function type and the set of slave network functions comprises all of the plurality of network functions of the predetermined network function type except for the selected master network function.

4. The method according to claim 1, wherein the master network function is located at a first site and at least one of the slave network functions in the set of slave network functions is located at the first site.

5. The method according to claim 1, wherein displaying the status of the configuration update for each of the slave network functions in the set of slave network functions comprises generating a graphical user interface.

6. The method according to claim 1, wherein the master network function is located at a first site and at least one of the slave network functions in the set of slave network functions is located at a different site than the first site.

7. The method according to claim 1, wherein the communication network is a 5G cellular network having a service-based architecture.

8. A system for providing a configuration update to a plurality of network functions of a predetermined network function type in a communication network; the system comprising:
a memory that stored one or more computer readable media that include instructions; and
one or more processor devices configured to execute the instructions of the computer readable media to:
receive a selection of a master network function from the plurality of network functions of the predetermined network function type;
apply the configuration update to the master network function;
provide the configuration update from the master network function to a set of slave network functions from the plurality of network functions of the predetermined network function type;
receive a status of the configuration update for each of the slave network functions in the set of slave network functions; and
display the status of the configuration update for each of the slave network functions in the set of slave network functions.

9. The system according to claim 8, wherein the one or more processor devices are configured to execute instructions of the computer readable media further to generate a graphical user interface to display the status of the configuration update for each of the slave network functions in the set of slave network functions.

10. The system according to claim 8, wherein the configuration update relates to a subset of the plurality of network functions of the predetermined network function type and the set of slave network functions comprises the subset of the plurality of network functions of the predetermined network function type.

11. The system according to claim 8, wherein the configuration update relates to all of the network functions in the plurality of network functions of the predetermined network function type and the set of slave network functions comprises all of the plurality of network functions of the predetermined network function type except for the selected master network function.

12. The system according to claim 8, wherein the master network function is located at a first site and at least one of the slave network functions in the set of slave network functions is located at the first site.

13. The system according to claim 8, wherein the master network function is located at a first site and at least one of the slave network functions in the set of slave network functions is located at a different site than the first site.

14. A non-transitory, computer-readable medium storing instructions, that, when executed by an electronic processor, perform a set of functions, the set of functions comprising:
receiving a selection of a master network function from a plurality of network functions of a predetermined network function type in a communication network;
applying the configuration update to the master network function;
providing the configuration update from the master network function to a set of slave network functions from the plurality of network functions of the predetermined network function type;
receiving, using the master network function, a status of the configuration update for each of the slave network functions in the set of slave network functions; and
displaying the status of the configuration update for each of the slave network functions in the set of slave network functions.

15. The non-transitory, computer-readable medium according to claim 14, wherein providing the configuration update from the master network function to a set of slave network functions from the plurality of network functions of the predetermined network function type comprises communicating the configuration update via a service-based interface of the communication network.

16. The non-transitory, computer-readable medium according to claim 14, wherein the configuration update relates to a subset of the plurality of network functions of the predetermined network function type and the set of slave network functions comprises the subset of the plurality of network functions of the predetermined network function type.

17. The non-transitory, computer-readable medium according to claim 14, wherein the configuration update relates to all of the network functions in the plurality of network functions of the predetermined network function type and the set of slave network functions comprises all of the plurality of network functions of the predetermined network function type except for the selected master network function.

18. The non-transitory, computer-readable medium according to claim 14, wherein the master network function is located at a first site and at least one of the slave network functions in the set of slave network functions is located at the first site.

19. The non-transitory, computer-readable medium according to claim 14, wherein the master network function is located at a first site and at least one of the slave network functions in the set of slave network functions is located at a different site than the first site.

20. The non-transitory, computer-readable medium according to claim 14, wherein the communication network is a 5G cellular network having a service-based architecture.
